(19) United States
(12) Patent Application Publication
(10) Pub. No.: US 2005/0121037 A1
(43) Pub. Date: Jun. 9, 2005

(54) Nasal ventilation interface

(76) Inventor: Thomas J. Wood, Blackshear, GA (US)

Correspondence Address: KCO LAW, PLLC / DBA: KEADY, OLDS,;MAIER & RICHARDSON, PLLC, PO BOX 20245, ALEXANDRIA, VA, 22320-1245, US

(21) Appl. No.: 10/912,222

(22) Filed: Aug. 6, 2004

Related U.S. Application Data
(60) Provisional application No. 60/493,325, filed on Aug. 8, 2003.

(51) Int. Cl. A62B 18/00; A62B 7/00

(52) U.S. Cl. 128/207.18; 128/201.22

(57) ABSTRACT

A ventilation interface and system is described which can be adapted to be connected to a source of ventilation. The ventilation interface and system may include improved headgear and nasal inserts with a curve.

### CROSS-REFERENCE TO RELATED APPLICATION

This application claims the benefit of priority under 35 U.S.C. 119 to U.S. Provisional Patent Application No. 60/493,325 entitled “REM-PAP” filed Aug. 8, 2003, the disclosure of which is expressly incorporated by reference herein in its entirety.

### BACKGROUND OF THE INVENTION

1. Field of the Invention

Exemplary embodiments of the invention are directed to a nasal ventilation interface adaptable to be connected to a source of ventilation.

2. Discussion of Related Art

Obstructive sleep apnea syndrome (commonly referred to as obstructive sleep apnea, sleep apnea syndrome, and/or sleep apnea) is a medical condition which includes repeated, prolonged episodes of cessation of breathing during sleep. During a period of wakefulness, the muscles of the upper part of the throat passage of an individual keep the passage open, thereby permitting an adequate amount of oxygen to flow into the lungs. During sleep, the throat passage tends to narrow due to the relaxation of the muscles. In those individuals having a relatively normally sized throat passage, the narrowed throat passage remains open enough to continue to permit the adequate amount of oxygen to flow into the lungs. However, in those individuals having a relatively smaller sized throat passage, the narrowed throat passage prohibits the adequate amount of oxygen from flowing into the lungs. Additionally, a nasal obstruction, such as a relatively large tongue, and/or certain shapes of the palate and/or the jaw of the individual further prohibit the adequate amount of oxygen from flowing into the lungs.

The individual having the above-discussed conditions can stop breathing for one or more prolonged periods of time (e.g., 10 seconds or more). The prolonged periods of time during which breathing is stopped, or apneas, are generally followed by sudden reflexive attempts to breathe. The reflexive attempts to breathe are generally accompanied by a change from a relatively deeper stage of sleep to a relatively lighter stage of sleep. As a result, the individual suffering from obstructive sleep apnea syndrome generally experiences fragmented sleep that is not restful. The fragmented sleep results in one or more of excessive and/or inappropriate daytime drowsiness, headache, weight gain or loss, limited attention span, memory loss, poor judgment, personality changes, lethargy, inability to maintain concentration, and/or depression.

Other medical conditions can also prevent individuals, including adults and infants, from receiving the adequate amount of oxygen into the lungs. For example, an infant who is born prematurely can have lungs that are not developed to an extent necessary to receive the adequate amount of oxygen. Further, prior to, during, and/or subsequent to certain medical procedures and/or medical treatments, an individual can be unable to receive the adequate amount of oxygen.

Under these circumstances, it is known to use a ventilation interface to apply a positive pressure to the throat of the individual, thereby permitting the adequate amount of oxygen to flow into the lungs. In the known ventilation interface, oxygen and/or room air containing oxygen is delivered through the mouth and/or nose of the individual. Known types of positive pressure applied by the known ventilation interface include continuous positive airway pressure (CPAP) in which a positive pressure is maintained in the throat passage throughout a respiratory cycle, bi-level positive airway pressure (BiPAP) in which a relatively high positive pressure is maintained during inspiration and a relatively low positive pressure is maintained during expiration, and intermittent mechanical positive pressure ventilation (IPPV) in which a positive pressure is applied when apnea is sensed (i.e., the positive airway pressure is applied intermittently or non-continuously).

One conventional ventilation interface for the application of such positive pressures includes a potentially heavy face mask that covers the nose and/or mouth, as well as a pair of nasal pillows that are inserted into corresponding nares of the naris.

In the conventional art, pressure must be applied between the required harness and the head of the individual to maintain the required seal. As a result, the harness is generally uncomfortable to wear, particularly when sleeping. The applied pressure often results in undesirable irritation and sores caused by movement of the mask and harness during periods of both wakefulness and sleep.

Further, the required seal is generally difficult to maintain when the mask and harness is moved. The mask also generally applies an undesirable pressure to the sinus area that is adjacent to the nose, causing the nasal sinus airways to narrow. This causes an increase in the velocity of flow through the upper anatomical airways and a decrease in the lateral pressure against the nasal mucosal walls. Additionally, the tubing may fold undesirably exacerbating the above problem.

The above-discussed combination of increased flow velocity and decreased pressure results in the removal of moisture from the mucosal walls during inspiration and may cause an undesirable drying and a burning sensation within the nares. As a result, the individual may remove the mask to alleviate these discomforts, consequently discontinuing the beneficial application of the positive pressure. Additionally the decreased pressure and increased air flow velocity deteriorate the laminar flow between the air input and output portions of the conventional mask.

Another conventional interface is the use of nasal inserts which directly enter the nares and force air pressure straight into a patient's nostrils. This straight airflow may result in sub-optimal air flow towards the upper nasal passages and potential discomfort and poor ergonomics.

### SUMMARY OF THE EXEMPLARY EMBODIMENTS OF THE INVENTION

A first exemplary embodiment of the present invention provides a nasal ventilation interface including a cannula connectable to a source of ventilation. The nasal ventilation interface further includes at least one curved nasal insert and a central reservoir with at least one exhaust port.

In another exemplary embodiment the present invention provides a nasal ventilation interface including a headgear with a cross bar configured to receive tubing. The nasal ventilation interface further includes a cannula with at least one substantially curved nasal insert and at least one exhaust port. The tubing may be configured to pass through the headgear and is connected to a source of ventilation gas at a first end and connected with the cannula at a second end.

In yet another exemplary embodiment the present invention provides a method of wearing a nasal ventilation interface. The method includes connecting tubing to a source of ventilation at a first end. Connecting the tubing with a cannula at a second end and connecting the tubing with at least one of a swivel and a headgear flange on a headgear. The method may also include inserting at least one curved nasal insert on a distal end of the cannula into a nares and lifting the curved nasal insert once inserted into the nares.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

### BRIEF DESCRIPTION OF THE DRAWINGS

Reference will now be made to the exemplary embodiments of the invention, examples of which are illustrated in the accompanying drawings. Wherever possible, the same reference numbers will be used throughout the drawings to refer to the same or like parts.

FIG. 1 shows a side elevational view of an exemplary embodiment of a ventilation interface system.

FIG. 2 shows a left front side view of an exemplary embodiment of a ventilation interface.

FIG. 3 shows an exploded side view of an exemplary embodiment of a ventilation interface.

FIG. 4 shows an exploded left front elevational view an exemplary embodiment of a ventilation interface.

### DETAILED DESCRIPTION OF THE EXEMPLARY EMBODIMENTS

Although the figures show certain exemplary embodiments of the nasal ventilation system, it is to be understood that the ventilation system can be of any type. One or more exemplary embodiments of the present invention will now be described with reference to the drawings, wherein like reference numbers throughout the several views identify like and/or similar elements.

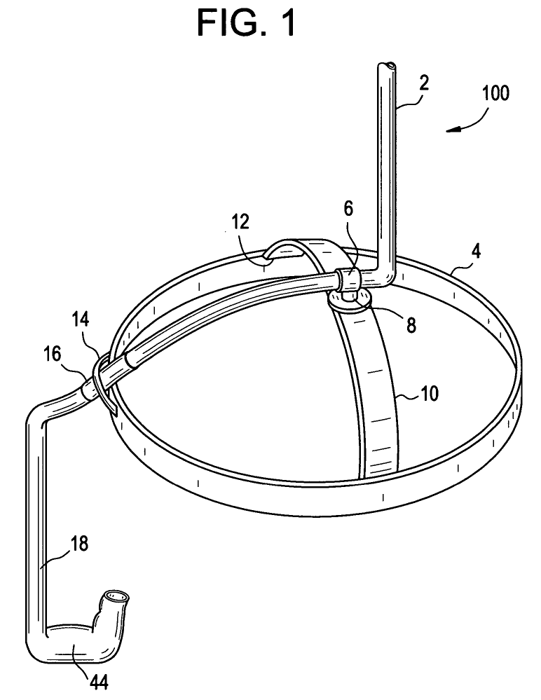

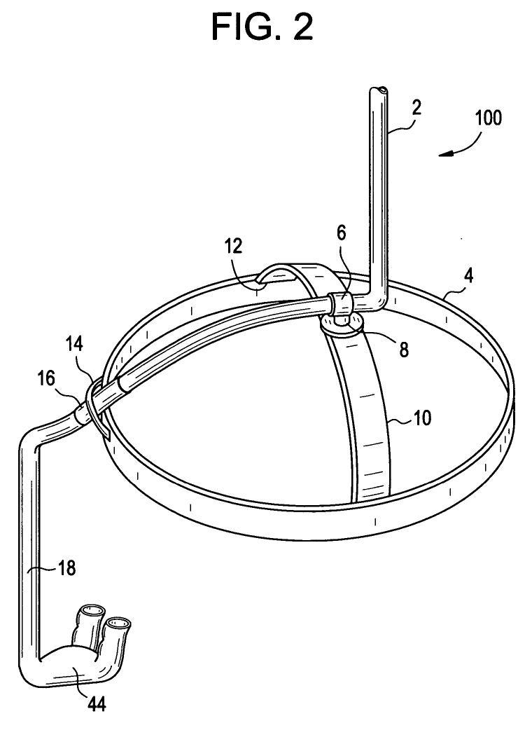

Exemplary embodiments of the present invention, as shown in FIGS. 1 and 2, provide a nasal ventilation interface system 100 that may include a cannula 44 that may configured to be connected to a ventilation source. The cannula 44 may connect to a source of ventilation gas, such as, oxygen and/or air containing oxygen, as non-limiting examples. The cannula 44 may include a feed tube connector 18 that connects to a feed tube 2. The single feed tube 2 provides a lighter weight for this type of nasal ventilation interface 100. The feed tube 2 may snake through a substantially U-shaped headgear flange 14 with a feed tube expansion point 16 which may aid in holding the tubing 2 in the headgear flange 14. The feed tube 2 then may proceed through an upper cross bar feed tube connection 6 which may be attached to a swivel 8 and then to a source of ventilation gas, such as, a mechanical ventilator or other pumping device (not shown).

The source of ventilation (not shown) may apply a positive pressure through the feed tube 2 to the cannula 44 and finally to nares and airway of a user, thereby permitting an adequate amount of continuous positive airway pressure to flow into the lungs. The headgear band 4 may have a headgear cross bar 10 connected to a headgear band 4 at cross bar connection points 12. The cross bar connection points 12 may be attached to the headgear band 4 by any adjustable configuration such as, Velcro®, snaps, adhesive and the like which are provided as few non-limiting examples. Likewise, the headgear band 4 and cross bar 10 may be made out of any suitable natural or synthetic material such as cotton, flannel, moleskin or nylon and the like, which are provided as a few non-limiting examples.

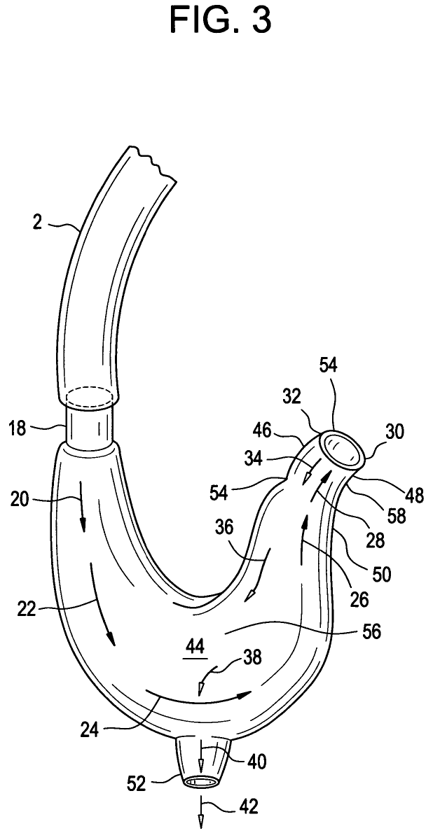

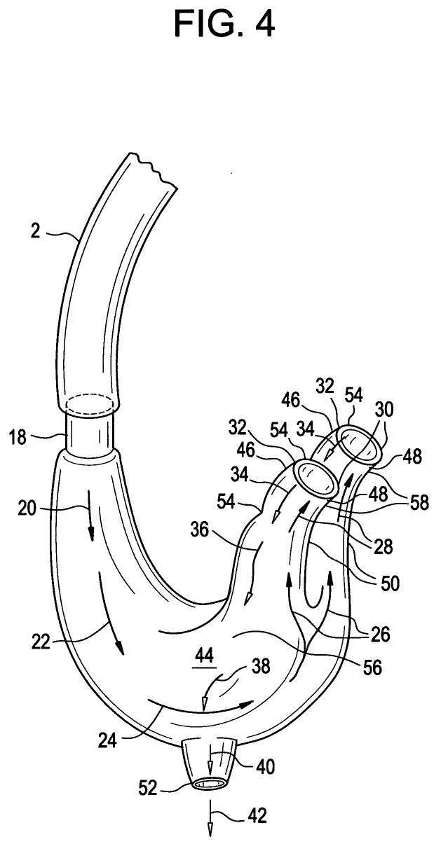

For example, as shown in FIGS. 3 and 4, a cannula 44 may include a feed tube connector 18, at least one curved nasal insert 30, at least one indentation 54, at least one thicker wall portion 50, a central reservoir 56, at least one exhaust port 52, and at least one connection portion 18. These and other portions of the cannula 44 will now be further described.

Now referring to FIGS. 3 and 4 the nasal inserts 30 will have a forward curve 46. The forward curve 46 of the nasal inserts 30 may range from 1° to 45° from the lower plane of the nasal insert 30 near the central reservoir 56. The forward curve 46 is more in contour with the pathway of nasal airways of a user. This forward curve or hook 46 may aid in delivering air pressure towards the natural geometric angle of the anatomical nasal sinus area and helps direct air flow in the direction of the upper nasal passages where the air movement may make a 180° turn and back down to the bifurcation of the lungs. This forward curve or hook shape 46 may also help anchor the nasal inserts 30 as a slight tug may be made to the feed tube 2 running along the front of the face which will give a slight lift to the tip of the nose. The nose is in contact with the nose tip contact portion 32 in and with the lower nostril contact portion 58 which increases the cross-section of flow space available in the upper nasal airways and allows for an increase in the number of air molecules to be delivered through this space. This may also help decrease the pressure drop between the delivery source and the targeted area of the apneic event and ultimately to the area of gas exchange (release of CO₂ and uptake of O₂).

This is just one aspect of the invention that is an improvement over the conventional mask which exerts pressure to the sinus areas and causes a narrowing of the upper nasal airways. The narrowing causes back pressure to the delivery source, increase in air velocity, decrease in lateral pressure, and a pressure drop at the point of the apneic event and ultimately a total number of air molecules at the point of gas exchange which decreases effective ventilation.

The front of the nasal insert 30 may have an indentation or a depression 54 and where it may come in contact with the front of the nose. The back of the nasal insert 30 may have a small outward curve 58 that may come into contact with the back of the nose. The cannula 44 could be designed to take away as much unwanted pressure against the tip of the nose as possible and help fill the gap in the rear of the nose when the cannula 44 is lifted by a slight tug on the feed tube 2 secured by the headgear causing an upward twist effect on the nasal inserts 30. This slight uplift of the nose may increase the airway patency of the nose and make CPAP therapy more effective. It may also serve to alleviate the effects of a deviated septum.

When fitted, the nasal inserts 30 may slightly push into the top of the nose and pull away from the back of the nose. This may cause discomfort at the tip of the nose and may also risk a slight air leak at the back of the nose. In at least one aspect of the invention it is desirable to create a seal without interfering with blood circulation in and around the nose which would cause patient discomfort and decrease patient compliance.

Additionally, the nasal inserts 30 may or may not be fitted with a rib, flange or raised area around the apex of the nasal insert 30 to aid in creating a seal with the nostrils. The seal may be created by at least one of the resiliency of the material used to make the inserts and possibly some enhancement from the slight twisting effect on the nasal insert 30 created by the tug on the feed tube 2 connected to the headgear. Additionally the headgear and tug on the feed tube may play a role in creating and maintaining a seal.

The central reservoir of the cannula 44 may provide an additional volume of air or gas molecules that, for example, allows for a decreased flow velocity through cannula 44 without a drop in pressure. In addition, central reservoir of the cannula 44 may be shaped in a variety of ways to optimize the laminar airflow 56 through the cannula 44.

For example, as shown in FIGS. 3-4 the central reservoir 56 may be shaped to allow a laminar flow through the cannula 44 between a nasal insert 30 and an exhaust port 52. In particular, the central reservoir 56 of the cannula 44 may have a shape and volume that is sufficient to slow the velocity of air or gas without dropping its pressure. This feature may increase the effectiveness of the cannula 44 for treating sleep apnea.

During sleep, the exhalation of a person's breath is driven by the elasticity of the lungs. For patients that use conventional sleep apnea devices, the contraction of the lungs during exhalation can become static during sleep, which interrupts the adequate exhalation and release of carbon dioxide. This may happen frequently with patients prescribed with conventional sleep apnea devices that use pressures outside the normal range of about 8 cm H₂O to about 12 cm H₂O. The pressure outside the normal range may be from about 3 cm H₂O to about 25 cm H₂O, and from about 12 cm H₂O to about 25 cm H₂O or higher. These conventional devices sometimes have extreme variations in continuous positive airway pressures, greater than the elasticity of the lung.

In contrast, in accordance with some embodiments of the present invention, a ventilation interface system that uses the cannula 44 with the central reservoir 56 can provide the ventilation gas from the ventilation source to the nares at a lower velocity thereby decreasing a drop in pressure and with improved laminar flow because the central reservoir 56 can hold an increased volume of air or gas. The resulting decrease in flow velocity decreases lateral pressure and in turn decreases the amount of moisture removed from the mucosal walls of a user, which increases the comfort of the user. Accordingly, the ventilation interface system consistent with at least one of exemplary embodiments of the present invention may provide better comfort and functionality and may be more ergonomical to wear, have lighter weight, and be more economical to produce than conventional systems.

Referring now back to FIGS. 3 and 4, an exhaust port 52 may be provided with central reservoir 56. The exhaust port 52 provides an outlet of air or gas from central reservoir 56 and assists with optimizing the airflow through the cannula center 56. For example, as shown in FIG. 3, the exhaust port 52 may be positioned on the central reservoir 56 midway between the feed tube connectors 18 and the distal end of the nasal insert 30. The cannula 44 may include a single exhaust port 52 with a substantially circular cross section. Alternatively, the cannula 44 may include a multiple exhaust ports 52 of various sizes which may be substantially circular or oval.

Alternatively, the exhaust port 52 may be configured with an adjustable aperature, which could be adjusted by a mechanism, such as a valve, which increases or decreases the size of the internal diameter of the exhaust port 52 and thereby varies the exhaust flow 40. Those skilled in the art would appreciate that the adjustable aperture of exhaust port 52 can be fitted to the various embodiments of the present invention.

As one non-limiting example of the use of the adjustable aperture, a doctor could prescribe a particular aperture setting to accommodate a particular patient's needs, thereby reducing the tendency for incoming pressure to overpower the elasticity of the lungs and prevent exhalation. For example, the mechanism may be helpful for CPAP users or other patients prescribed with excessive pressures ranging from about 3 cm H₂O to about 25 cm H₂O or higher. For some patients, the ranges may be from 5 cm H₂O to 20 cm H₂O, 8 cm H₂₀ to 15 cm H₂O or 10 cm H₂O to 12 H₂O.

In addition to treating sleep apnea, the mechanism may be integrated or removable from the cannula 44 and configured to facilitate flow of any type of gas that may be used in a dental office or hospital. For example, the cannula 44 may be fitted with a mechanism to allow for the administration of general anesthesia or other type of gas, such as a nitrous oxide.

FIGS. 3-4 illustrate the general paths of flow through the cannula 44. For example, a first inflow portion 20 may begin near the feed tube connector 18 from a ventilation source supply air to a feed tube 2. A second inflow portion 22 leads to the central cannula reservoir 56 and to a third inflow portion 24. The nasal insert 30 then forms a fourth inflow portion 26, which eventually leads into a fifth inflow portion 28 and to the nasal passages of the user. Included in inflow portion 24 may be a slight bleed off at exhaust port 52 which may be adjustable as discussed above.

During exhalation by the user, the nasal insert 30 forms a first outflow portion 34. The central reservoir 56 then forms second and third outflow portions 36 and 38 respectively. As noted above, the central reservoir 44 may be shaped and configured such that the velocity of outflow portions 36 and 38 may be reduced without substantially affecting the pressure of the inflow portions or outflow portions. The exhaust port 52 then forms a fourth outflow portion 40. The fifth outflow portion 42 becomes expelled air out of the exhaust port 52.

The exhaust port 52, the nasal insert 30, and the central reservoir of the cannula 44 may be configured to allow for improved laminar flow 44 between inflow portions 20, 22, 24, 26 and 28 and outflow portions 34, 36, 38, 40 and 42. In particular, the volume of the central reservoir of the cannula 44 creates room for the gas and decreases the flow velocity of these flow portions and decreases the pressure drop. This decrease in flow velocity reduces any dryness and irritation that a user may otherwise have as a result of higher flow velocities which increase the venturi effect along the nasal mucosa membrane. The cannula 56 can increase the desired amount of pressure that prevents the apneas by increasing the number of air molecules. The central reservoir 56 may further reduce the likelihood of any turbulent activity between the third inflow portion 24 and the third outflow portion 38.

Numerous additional modifications and variations of the exemplary embodiment of the present invention are possible in light of the above teachings. It is therefore to be understood that within the scope of the appended claims, exemplary embodiments of the present invention may be practiced otherwise than as specifically described herein.

1. A nasal ventilation interface comprising:
a cannula connectable to a source of ventilation gas;
at least one substantially curved nasal insert;
at least one exhaust port;
a central reservoir positioned between the at least one curved nasal insert and the at least one exhaust port.

2. The nasal ventilation interface according to claim 1, wherein the at least one substantially curved nasal insert includes an indentation on a first surface.

3. The nasal ventilation interface according to claim 1, wherein the at least one substantially curved nasal insert includes an outward curve on a second surface.

4. The nasal ventilation interface according to claim 1, wherein an indention on a first surface provides a thin wall on the first surface.

5. The nasal ventilation interface according to claim 1, wherein an outward curve on a second surface provides a thick wall on the second surface.

6. The nasal ventilation interface according to claim 1, wherein the cannula is configured for laminar flow.

7. The nasal ventilation interface according to claim 1, wherein the at least one exhaust port is inline with exhaled nasal exhaust.

8. The nasal ventilation interface according to claim 1, wherein the cannula is made of at least one of a plastic, silicone and polycarbonate shell.

9. The nasal ventilation interface according to claim 1, wherein the at least one nasal insert is configured to lift the tip of a user's nose.

10. The nasal ventilation interface according to claim 2, wherein the indentation on the first surface is configured to direct air flow towards an upper nasal passage.

11. The nasal ventilation interface according to claim 3, wherein the outward curve on the second surface is configured to direct air flow towards an upper nasal passage.

12. A nasal ventilation interface comprising:
headgear with a cross bar configured to receive tubing;
a cannula with at least one substantially curved nasal insert and at least one exhaust port;
wherein the tubing is configured through the headgear and is connected to a source of ventilation gas at a first end and connected with the cannula at a second end.

13. The nasal ventilation interface according to claim 12, wherein the crossbar includes a swivel.

14. The nasal ventilation interface according to claim 12, wherein the headgear includes a connection flange.

15. The nasal ventilation interface according to claim 12, wherein the tubing and headgear are configured to lift the distal end of the at least one nasal insert.

16. The nasal ventilation interface according to claim 12, wherein the tubing and headgear are configured to twist the distal end of the at least one nasal insert.

17. The nasal ventilation interface according to claim 12, wherein the headgear and tubing is configured to lifting the at least one nasal insert.

18. The nasal ventilation interface according to claim 12, wherein the headgear and tubing are configured to provide a twisting the at least one nasal insert.

19. The nasal ventilation interface according to claim 12, further comprising means for alleviating a deviated septum.

20. A method of wearing a nasal ventilation interface comprising:
connecting tubing to a source of ventilation at a first end;
connection the tubing with a cannula at a second end;
connecting the tubing with at least one of a swivel and a headgear flange on a headgear;
inserting at least one curved nasal insert on a distal end of the cannula into a nares;
lifting the curved nasal insert once inserted into the nares.

21. The method of wearing a nasal ventilation interface according to claim 20, further comprising:
increasing a cross sectional area of a user's nasal flow space.
